(19) United States
(12) Patent Application Publication
(10) Pub. No.: US 2012/0010925 A1
(43) Pub. Date: Jan. 12, 2012

(54) Consolidation Potential Score Model

(75) Inventor: Sujoy Mitra, Mumbai (IN)

(73) Assignee: PATNI COMPUTER SYSTEMS LTD., Mumbai (IN)

(21) Appl. No.: 13/178,177

(22) Filed: Jul. 7, 2011

Related U.S. Application Data
(60) Provisional application No. 61/362,137, filed on Jul. 7, 2010.

(51) Int. Cl. G06Q 10/00

(52) U.S. Cl. 705/7.38; 705/7.11

(57) ABSTRACT

A method of evaluating vendor capability includes selecting a set of grouping strategies, each grouping strategy including one or more application groups, calculating a component consolidation potential (CP) score for each application group in each grouping strategy, determining a value for each application group in each grouping strategy, calculating a net CP score for each grouping strategy using the values and the component CP scores, selecting a grouping strategy from the set of grouping strategies based on the net CP scores, and evaluating vendor capability according to the selected grouping strategy.

### CROSS-REFERENCE TO RELATED APPLICATION

This application claims the benefit of U.S. Provisional Application No. 61/362,137, filed Jul. 7, 2010, which is incorporated by reference in its entirety.

### TECHNICAL FIELD

The present invention relates to methods of business process optimization, and more particularly to methods of evaluating and consolidating vendors.

### BACKGROUND ART

Supplier evaluation is typically done using a parameter-driven scoring model, wherein the buyer rates the supplier based on various criteria. Each of these criteria usually is weighted and the end-result is a score for each supplier which can be compared with another supplier's score to determine vendor selection, rejection, and/or replacement. Traditional methods provide a comparative score of each supplier/vendor.

### SUMMARY OF THE INVENTION

In a first embodiment of the invention there is provided a method of evaluating vendor capability. The method includes selecting a set of grouping strategies, each grouping strategy including a plurality of application groups, calculating a component consolidation potential (CP) score for each application group in each grouping strategy, determining a value for each application group in each grouping strategy, calculating a net CP score for each grouping strategy using the values and the component CP scores, selecting a grouping strategy from the grouping strategies based on the net CP scores, and evaluating vendor capability according to the selected grouping strategy.

In related embodiments, a set of parameter weights are determined for a set of parameters. Calculating a component CP score is based on values of the parameters and the weights. Evaluating vendor capability may include using complexity evaluations of the vendors and performance evaluations of the vendors. A performance score and a complexity score may be calculated for each of a set of vendors associated with an application group in the selected grouping strategy. Calculating a performance score may include determining a set of performance parameter weights for a set of performance parameters and calculating a performance score based on values of the performance parameters and the performance parameter weights. Calculating a complexity score may include determining a set of complexity parameter weights for a set of complexity parameters, and calculating a complexity score based on values of the complexity parameters and the complexity parameter weights. Evaluating vendor capability may further include evaluating vendor capability based on the performance score and the complexity score. Evaluating vendor capability may further include evaluating vendor capability based on maintenance cost.

### BRIEF DESCRIPTION OF THE DRAWINGS

The foregoing features of the invention will be more readily understood by reference to the following detailed description, taken with reference to the accompanying drawings, in which:

FIG. 1A is a flowchart of a process for selecting a strategy for vendor consolidation.

FIG. 1B is a flowchart of a process for evaluating vendors.

FIG. 2 is a flowchart showing details of a step in the flowchart of FIG. 1A.

FIG. 3 is a table showing details of a step in the flowchart of FIG. 1A.

FIG. 3A is a table showing details of a step in the flowchart of FIG. 1A.

FIG. 4 is a table showing details of a step in the flowchart of FIG. 1A.

FIG. 5 is a table showing implementation details in an exemplary embodiment of a step in the flowchart of FIG. 1A.

FIG. 6 is a table showing details of a step in the flowchart of FIG. 1A.

FIG. 7 is a table showing implementation details in an exemplary embodiment of a step in the flowchart of FIG. 1A.

FIG. 7A is a flowchart showing details of a step in the flowchart of FIG. 1A.

FIG. 7B is a flowchart showing details of a step in the flowchart of FIG. 7A.

FIG. 8 is a chart showing details of a step in the flowchart of FIG. 1A.

FIG. 9 is a chart showing implementation details in an exemplary embodiment of a step in the flowchart of FIG. 1A.

FIG. 10 is a table showing details of a step in the flowchart of FIG. 1B.

FIG. 10A is a table showing details of a step in the flowchart of FIG. 1B.

FIG. 11 is a table showing details of a step in the flowchart of FIG. 1B.

FIG. 11A is a table showing details of a step in the flowchart of FIG. 1B.

FIG. 12 is a chart showing details of a step in the flowchart of FIG. 1B.

FIG. 13 is a chart showing implementation details in an exemplary embodiment of steps in the flowchart of FIG. 1B.

FIG. 14 is a list of implementation details in an exemplary embodiment of a step in the flowchart of FIG. 1B.

### DETAILED DESCRIPTION OF SPECIFIC EMBODIMENTS

The biggest inefficiencies with prior art methods of supplier evaluation, in particular in relation to information technology (IT) vendors, are:

First, these methods do not compare the benefit of vendor consolidation that the buyer would accrue by consolidating IT vendors business process-wise, segment-wise (or business unit-wise), geography-wise or technology-wise. Actually, the entire IT portfolio of the buyer can be classified vertically (e.g., business process-wise/segment-wise) as well as horizontally (e.g., technology-wise). If cost reduction is the motto of IT vendor consolidation, then the buyer should evaluate whether there might be greater cost savings by consolidating the vendors segment-wise v technology-wise. Thus, such an objective business evaluation of maximizing benefits of IT vendor consolidation is missing while starting the IT vendor/supplier assessment.

Second, while selecting/rejecting/replacing the IT vendors, there is no roadmap for the buyer to take any decision on the vendors in the short, medium or long term. In effect, there is no vendor selection/replacement roadmap. Embodiments of the present invention provide solutions that address these inefficiencies.

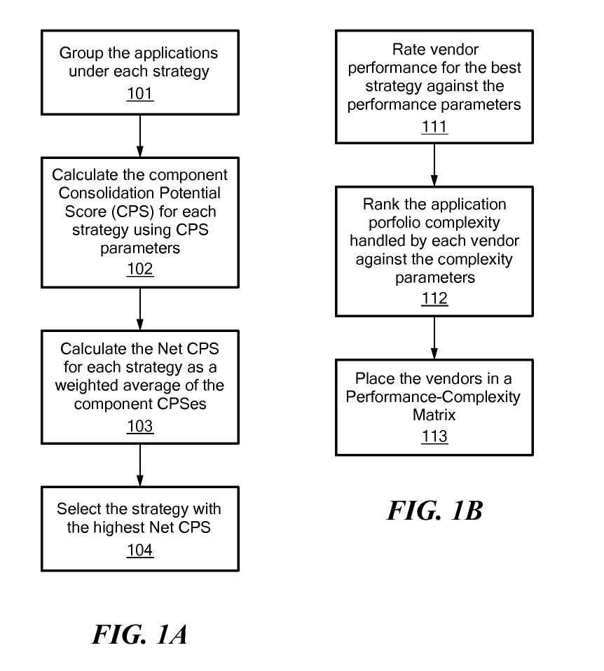

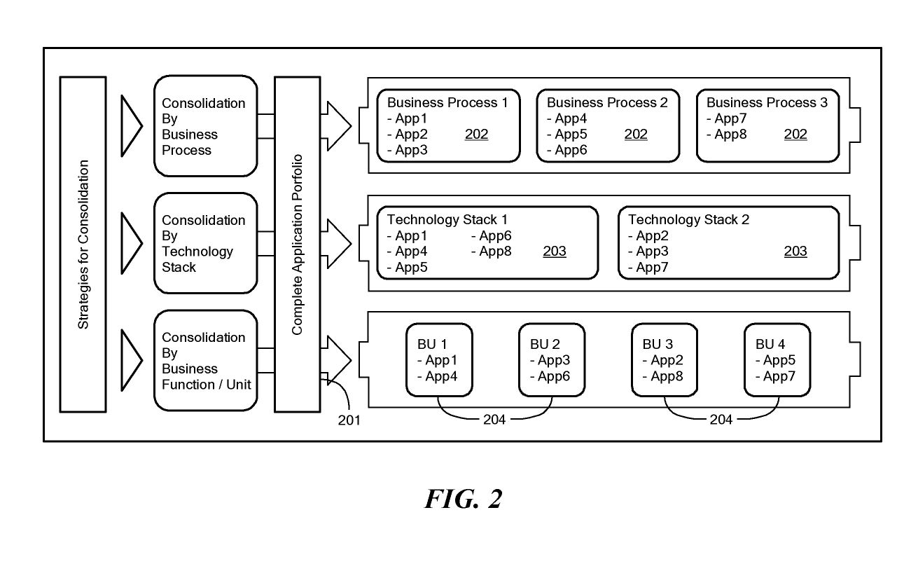

FIG. 1A is a flowchart of a process for selecting a strategy for vendor consolidation. A user of the process seeks to analyze a plurality of IT applications that are serviced by a plurality of IT vendors. The user seeks to identify a roadmap for consolidating IT vendors, leading to cost savings and/or improved quality of IT service for the enterprise. In step 101, the plurality of applications are grouped under a plurality of strategies. Each strategy defines a particular division of the plurality of applications into exactly one of a plurality of groups. Grouping of applications into strategies is now explained in greater detail with reference to FIG. 2, which is a flowchart showing details of step 101 in the flowchart of FIG. 1A.

FIG. 2 illustrates an embodiment in which three strategies have been selected for evaluation: 1) consolidation by business process, 2) consolidation by technology stack, and 3) consolidation by business function/business unit. In the illustrated example, a complete application portfolio 201 includes eight distinct applications, labeled App1-App8. In practice, any number of applications may be considered. The applications may belong to various business processes 202, such as Business Process 1-Business Process 3. In the present example, Business Process 1 includes App1, App2 and App3. Business Process 2 includes App4, App5 and App6. Business Process 3 includes App7 and App8. A grouping of applications within a strategy, such as Business Process 1, is referred to as a “strategy component” of that strategy.

Applications may be grouped differently for each strategy. For example, when grouping by technology stack, applications may be grouped in terms of their underlying technology, such as Java/J2EE, Oracle database, Siebel CRM, Lotus Domino, or Informatica, or they can be grouped based on their intended usage (e.g., desktop versus mainframe). Similarly, when grouping on the basis of business processes, applications may be sorted based on their deployment in Distribution and Logistics, Customer Service, Product Design, Sales and Marketing, or Shared Services, for example.

Similarly, the applications may belong to various technology stacks 203, such as Technology Stack 1 and Technology Stack 2. In the present example, Technology Stack 1 includes App1, App4, App5, App6 and App8, while Technology Stack 2 includes the remaining App2, App3 and App7. The applications also may belong to various business units 204, such as BU 1-BU 4. In the present example, BU 1 includes App1 and App4, BU 2 includes App3 and App6, BU 3 includes App2 and App8, and BU 4 includes App5 and App7.

Embodiments of the invention may employ the strategies shown here, or other strategies may be selected as appropriate. In some embodiments, geographical location of IT components may be considered as part of a strategy. Furthermore, strategies are not limited to precise categories such as those listed here. Any possible mapping of target applications into a plurality of groups may be considered as a strategy as circumstances dictate.

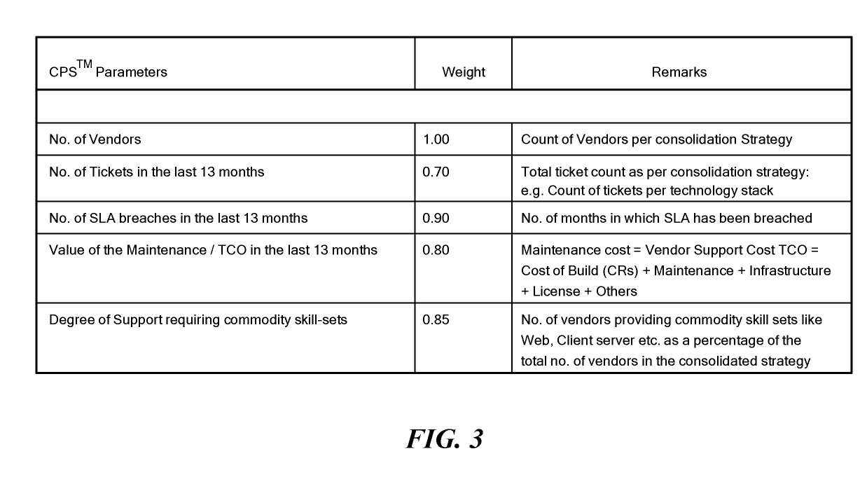

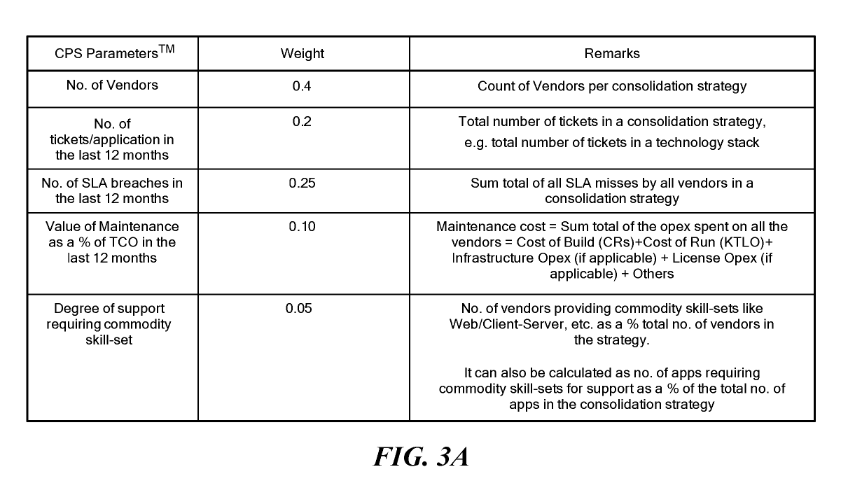

Returning to FIG. 1A, once a plurality of candidate strategies has been identified in step 101, a component consolidation potential (CP) score is calculated for each strategy component in each strategy in step 102. FIG. 3 is a table showing details of this step. A component CP score is a metric representing a relative amount of potential benefit that may be realized by consolidating vendors with respect to the strategy component in question. A component CP score is calculated on the basis of a set of parameters. Exemplary parameters are shown in FIGS. 3 and 3A. For example, one parameter may be a number of vendors currently servicing the applications of the strategy component. Another parameter may be a number of tickets originating from applications in the strategy component over a historical period, such as the previous 13 months. Another possible parameter, shown in FIG. 3, is a number of months out of the last 13 months in which a service-level-agreement breach has occurred. FIG. 3 also shows a parameter equal to a value of maintenance as a percentage of total cost of ownership (TCO) over the last 13 months. Maintenance cost is simply the cost of vendor support. TCO is calculated by adding a number of values, including a cost of building a system, the maintenance cost, costs of the infrastructure and any necessary licenses, etc. A final parameter shown in FIG. 3 is a measure of how much of the strategy component requires commodity skill sets.

Each parameter may have an associated weight. The weight is customizable and is chosen in relation to the relative importance of the parameter. In some embodiments, the weights are computed using analytical hierarchical processing which rates each parameter on an ordinal scale of 1-9 stating the relative importance of one against another. Further exemplary parameters according to an embodiment of the present invention are shown in FIG. 3A, in which the weights of the various parameters have been normalized so that they add up to 1.0.

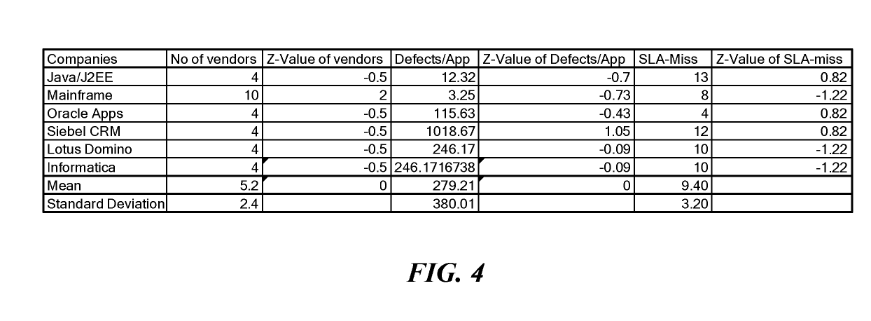

The value of each parameter also may be normalized. For example, normalizing parameter values may include computing a “Z-score,” where the Z-score is found by subtracting the mean value of the parameter from the particular parameter values and dividing by the standard deviation of the parameter values. Further details relating to such an embodiment are given in FIG. 4.

In some embodiments, normalizing parameter values may include comparing a parameter value to a maximum value and adjusting the parameter value according to the percentage of the maximum value that the actual value represents. If a particular strategy component has four total associated vendors, and there are a total of eleven vendors associated with the enterprise as a whole, then the parameter “number of vendors” may be set to a value proportional to 4/11, or 36.36%, which is the percent of a maximum or total value realized by this parameter for this strategy component. In one embodiment, all parameter values may be normalized to have values between 0-100, in which case this example parameter value could be normalized to be 36.36.

Normalization allows parameters having widely disparate raw values to be combined into a composite score such that parameters tending to have small raw values are treated as equally important relative to parameters tending to have large raw values. Normalized parameter values are further adjusted according to the customizable weights to fine-tune the importance of the parameters relative to each other. In some embodiments, composite weights may be calculated, such that multiplying a raw parameter value by the corresponding composite weight yields a value representing a fully normalized and reweighted parameter value.

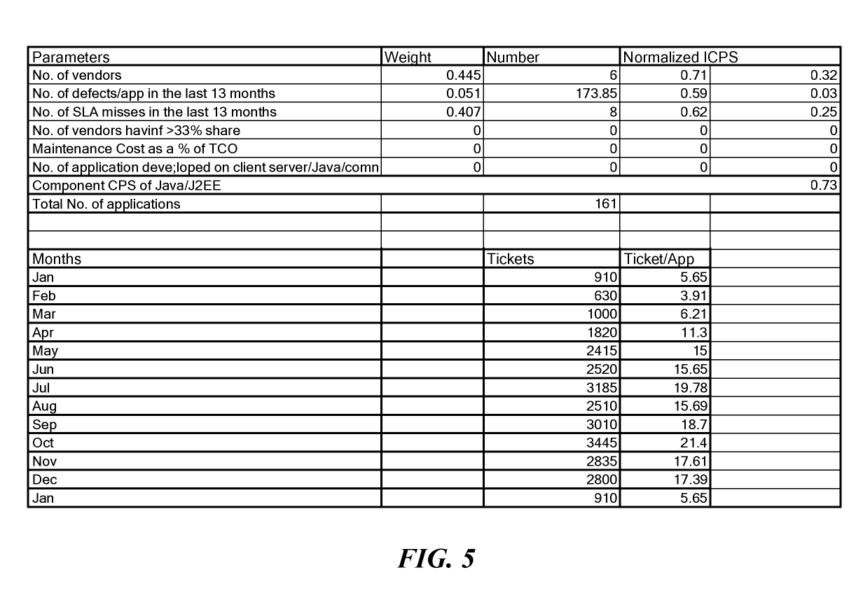

The normalized values of the parameters for a strategy component and the weights associated with those parameters are used to calculate a CP score for the parameter relative to the strategy component. FIG. 5 shows a detailed example of calculation of parameter CP scores and a combination of these values to obtain a CP score for a strategy component. In this case, the candidate strategy under consideration is consolidation by technology stack. The values shown are for the particular technology, e.g., Java/J2EE. For each parameter listed, a weight, a raw value (number), and a normalized number are shown. The normalized numbers are multiplied by the weights to calculate the parameter CP scores (shown in column “CPS”). The parameter consolidation scores are then added to calculate a component CP score for the strategy component “Java/J2EE.”

With reference again to FIG. 1A, after component CP scores are calculated for each strategy component, a net CP score is calculated for each strategy in step 103. Each strategy component within a strategy is assigned a value corresponding to the relative importance of that strategy component. In some embodiments, the values are computed using a methodology based on the Lens method, although other methods may be used. The client estimates the business criticality (e.g., in dollar-impact of downtime or over an ordinal scale of 0-5) of each application (assumed to be a dependent factor) against certain independent factors such as whether the application is a client-facing or partner-facing application, etc. Thereafter, a regression analysis of the independent factors may be performed against the dependent factor. The coefficient of each independent factor may then be used to compute the business criticality of each business process, business unit, technology domain, etc.

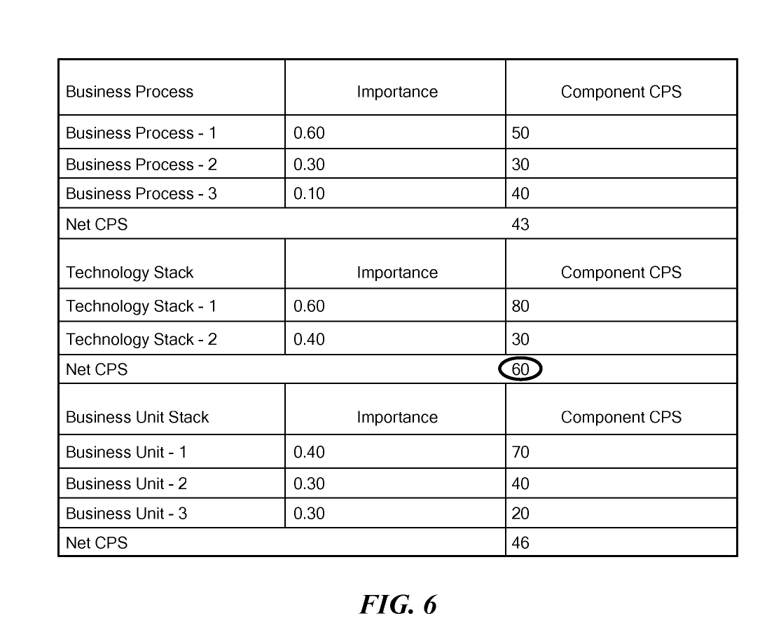

In the embodiment shown in FIG. 6, the importance values have been chosen so that they sum to 1. The component CP scores are multiplied by the associated importance values, and the resulting values are summed to produce a net CP score for the consolidation strategy as a whole. Thus, each business process is assigned a weight, and the net CP score is equal to the weighted average of the component CP scores. As can be seen from this Figure, the three business processes had weights of 0.6, 0.3, and 0.1 and component CP scores of 50, 30, and 40, respectively. Thus, the net CP score for the strategy of consolidation by business process is 43. Similarly, the net CP score for the strategy of consolidation by technology stack is 60, and the net CP score for the strategy of consolidation by business unit stack is 46. Thus, the highest score is associated with consolidation by technology stack and is circled in FIG. 6.

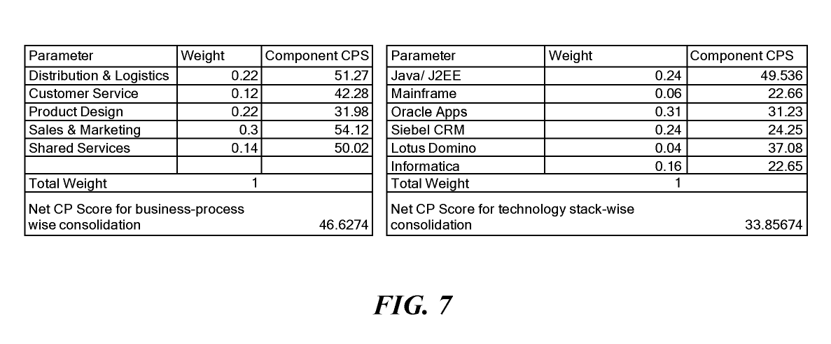

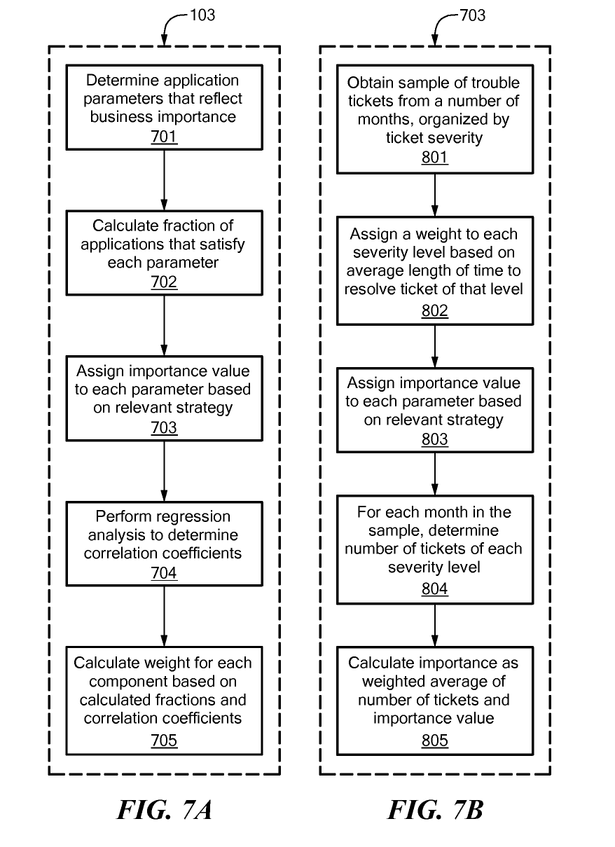

FIG. 7 shows how step 103 is performed in a detailed example according to an alternate embodiment of the present invention. In this example, the candidate consolidation strategies under evaluation are consolidation by business-process and consolidation by technology stack. The component CP scores for each of the parameters, as calculated according to the process illustrated in FIG. 5, are added to produce a net CP score for each of the two consolidation strategies as shown in FIG. 6.

In this example embodiment, weights for each component are calculated as a function of application parameters in a multi-step process shown in FIG. 7A. In the first step 701, parameters are determined that reflect the business importance or criticality of applications generally. Indicative parameters include, among others: application access in multiple countries; whether the application is accessed by clients; whether the application is accessed by partners; the impact of the application on revenue; and the impact of the application on brand image. Second, for each parameter, the fraction of applications that satisfy each parameter is calculated in step 702. In step 703, which may be done at the same time as step 702, for each scenario separately, an importance value is assigned to each parameter. In some embodiments, the importance value is related to the monetary impact of system downtime. In other embodiments, the importance value is a function of the number and severity of trouble tickets associated with the various applications, as described in more detail below. Next, in step 704 a regression analysis is performed to determine the correlation coefficients of the importance values. Finally, in step 705 the overall weight for the given component is calculated as a weighted average of the parameter values, where the weights are equal to the correlation coefficients just determined. Thus, each strategy component weight may be calculated as W=m₁*x₁+m₂*x₂+ . . . +c, where m₁, m₂, and so on are the correlation coefficients for each parameter, and x₁, x₁, and so on are the fractions of applications that satisfy each parameter respectively. The constant c may be used to provide an appropriate range of calculated weights. The computed weight for the given component then may be adjusted, for example by adding or multiplying by a fixed offset, so that the collection of computed weights are appropriately normalized. For example, if the sum of the computed weights is X, each individual weight may be multiplied by the reciprocal of X so that the sum of the normalized weights is 1.0.

Step 703 may include calculations to determine the importance value for any given parameter. For example, FIG. 7B shows a computation of the relative business importance owing to the level and severity of trouble tickets generated for applications. In process 801, a sample of trouble tickets from a number of different months (e.g., between 30 and 50) over the past three to five years is obtained. Tickets are organized by level of ticket severity. In process 802, each severity level is assigned a weight based on the number of hours required to resolve a ticket of that level under a service level agreement. For example, a problem that generates a level 1 ticket may require two hours to resolve, a level 2 ticket may require four hours, and a level 3 ticket may require ten hours. In this example, one assigns a weight inverse to the length of time, so the level 1 weight is 0.5 (i.e., ½), the level 2 weight is 0.25 (i.e. ¼), and the level 3 weight is 0.1 (i.e., 1/10).

In process 804, for each of the months in the sample, the number of tickets of each level of severity is determined. Then, the overall business importance of each month is determined in process 805, for each severity level, based on a weighted average of ticket count. Thus, relative business importance owing to ticket severity is computed as a function of the set of parameters. In context, this business importance value is one of the many such parameter values, determined in step 703, that are themselves correlated and averaged to form a final weight for a given strategy component, as described above.

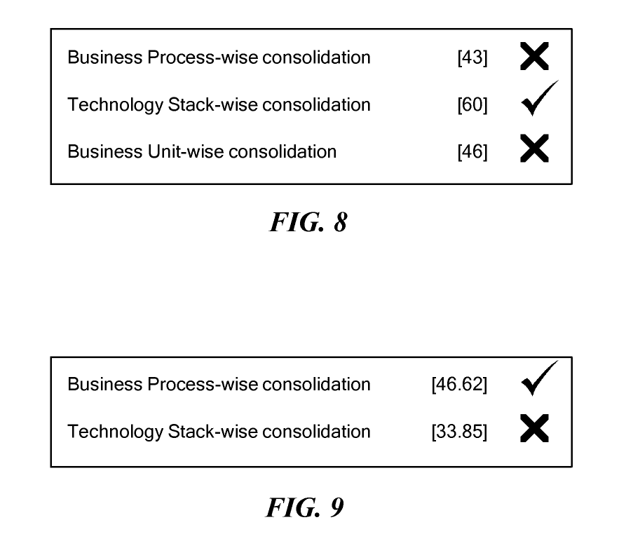

With reference again to FIG. 1A, once a net CP score has been calculated for each of the candidate consolidation strategies, in step 104 the strategy having the highest net CP score is chosen for implementation, as shown in FIGS. 8 and 9. In the example shown in FIG. 8, consolidation by technology stack has the highest net CP score, and is adopted as the chosen consolidation strategy. In the example shown in FIG. 9, consolidation by business process has the highest net CP score, and is adopted as the chosen consolidation strategy.

A buyer may wish to compare many vendors, using different consolidation strategies, for dozens or even hundreds of enterprise applications. Further, each application must be evaluated according to many parameters, sometimes dozens, and each parameter itself may be weighted according to the results of regression analyses. Moreover, the weights themselves may be determined using sub-analyses, as was shown in the case of FIG. 7A. Thus, as performing these calculations completely and accurately is an extremely complex undertaking, a typical embodiment of the invention must be implemented using a computer or other computing device known in the art.

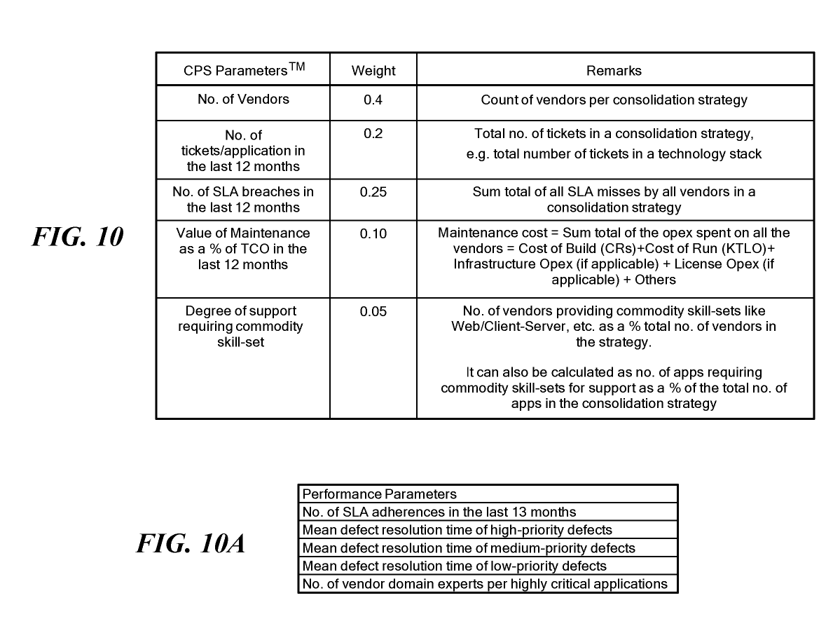

FIG. 1B is a flowchart of a process for evaluating vendors. Having selected a strategy for vendor consolidation in the process shown in FIG. 1A, the user develops a roadmap for how to perform vendor consolidation according to the chosen strategy. In step 111, vendors are rated according to their performance, resulting in a performance score for each vendor relative to each strategy component. Performance scores are calculated according to performance parameters, such as those shown in FIG. 10. The performance parameters shown in FIG. 10 are similar to the parameters used in FIG. 3 for determining consolidation potential, but any parameters representative of a vendor's performance may be used. Further exemplary performance parameters according to an embodiment of the present invention are shown in FIG. 10A.

Values for the performance parameters are calculated for each vendor for each strategy component in the chosen strategy. For example, if the chosen strategy is consolidation by technology stack, a performance score may be calculated for each vendor supporting Java/J2EE, another performance score may be calculated for each vendor supporting Oracle, and so on for each strategy component (i.e., for each technology stack).

One exemplary performance parameter is the number of defects that have occurred in applications supported by the vendor over a historical period, such as the last 13 months. Another performance parameter may be the number of months in which a service-level-agreement was adhered to over the same period of time. Other performance parameters may include the mean defect resolution time of high-priority defects.

Each of the performance parameters may be assigned a weight. The weight of a performance parameter is customizable and is chosen in relation to the relative importance of the parameter. Alternatively, the weight can also be computed by using the concepts of Lens Model.

Referring again to FIG. 1B, in step 112 vendors are rated according to the complexity of the application portfolios they handle. Rating of vendors includes providing values for complexity parameters representative of the complexity of the application portfolio handled by each vendor. As with performance parameters, complexity parameters are evaluated for each vendor relative to each strategy component. For example, if the chosen strategy is consolidation by technology stack, a complexity score may be calculated for each vendor supporting Java/J2EE, as well as a complexity score for each vendor supporting Oracle, etc.

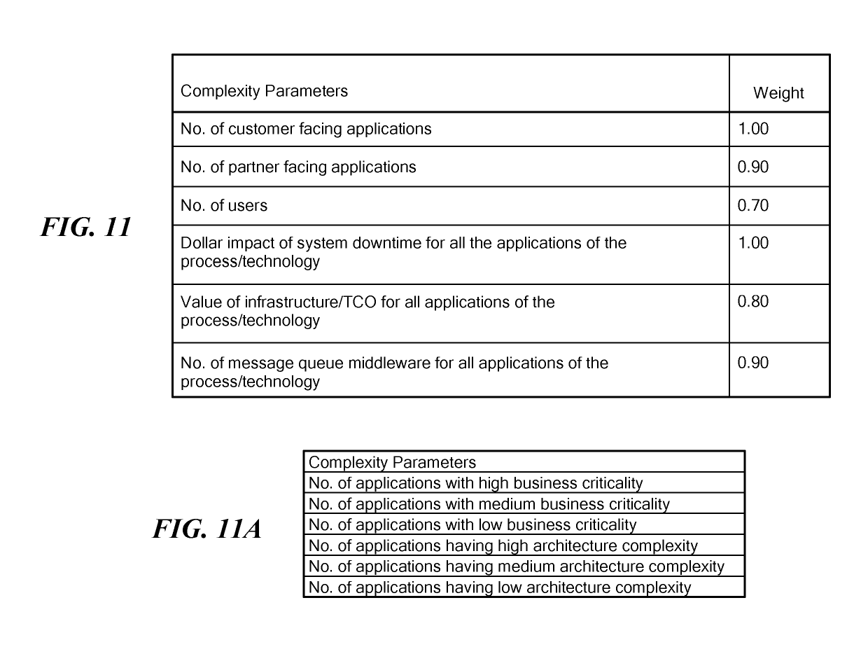

Weights are assigned to the complexity parameters that are used in combining values for complexity parameters to determine a complexity score for each vendor for each strategy component. The weight of a complexity parameter is customizable and is chosen in relation to the relative importance of the parameter. Alternatively, the weight can also be computed by using the concepts of Lens Model. Some exemplary performance parameters according to a specific embodiment of the present invention are shown in FIGS. 11 and 11A.

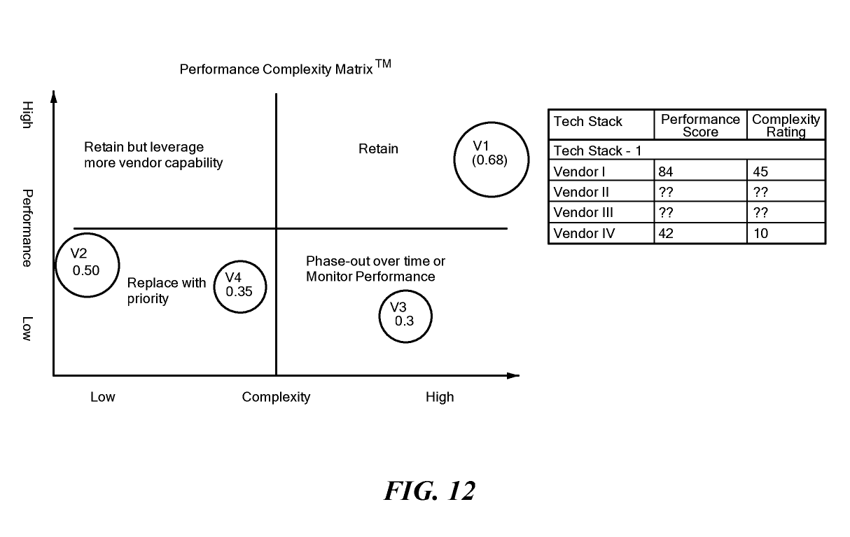

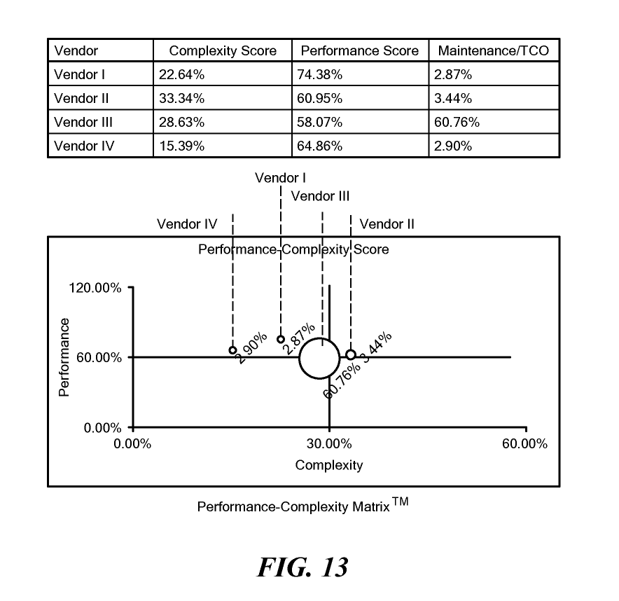

Referring again to FIG. 1B, in step 113 vendors are marked over a performance-complexity matrix. Exemplary performance-complexity matrices are shown in FIGS. 12 and 13. A performance complexity matrix is a visual representation of performance scores and complexity scores of a plurality of vendors associated with a particular strategy component. In certain embodiments of the present invention, the information that has been developed may be analyzed according to alternate arrangements, such as through presentation in one or more tables. Other embodiments may develop a roadmap for vendor consolidation without requiring a visual representation such as a performance-complexity matrix. Each vendor is represented on a two-dimensional coordinate system at a point having coordinates defined by the performance score and the complexity score associated with the vendor for the strategy component associated with the performance-complexity matrix. The point on the coordinate system may define the center of a circle that is represented on the complexity matrix. For example, the circle may have a radius proportional to the maintenance cost as a percentage of the total cost of ownership of the applications in the strategy component supported by the vendor or the service rates per person or asset of the vendor. FIG. 12 illustrates a case where four vendors are marked in relation to the strategy component “Tech Stack-I.” According to the coordinate system shown in FIG. 12, complexity score is graphed along the x-axis, and performance score is graphed along the y-axis.

The performance-complexity matrix may be used in developing a roadmap for vendor consolidation. As shown in FIG. 12, the coordinate system may be divided into regions of high and low complexity, as well as into areas of high and low performance. Vendors falling into both the low complexity and the low performance regions may be slated in the roadmap for replacement with priority. While low performance may in some cases be explained or accepted as a result of high complexity, if a vendor scores low on both a performance score and a complexity score, presumably an alternative vendor will be able to support the same applications with better results. In the case where a vendor displays low performance but also has a high complexity score, the roadmap may indicate that such a vendor should be replaced by being phased out over time or the performance should be monitored. In the case of a vendor displaying high performance but low complexity, such a vendor may be retained, but the roadmap may indicate that the vendor may be leveraged for additional capability (which will increase the overall complexity of the application portfolio supported by the vendor). Vendors displaying both high performance and high complexity typically are slated in the roadmap for retention.

In addition to considerations of high or low performance and high or low complexity, maintenance cost as a percentage of total cost of ownership or service rate may be used in developing the roadmap for vendor consolidation. For example, if two vendors are slated for replacement according to similar priorities, the vendor representing the greatest cost will be given a higher priority. For example, in FIG. 12, both Vendor 2 and Vendor 4 are slated for replacement with priority. Vendor 2, however, represents a greater cost than Vendor 4, and thus Vendor 2 is slated for replacement before Vendor 4.

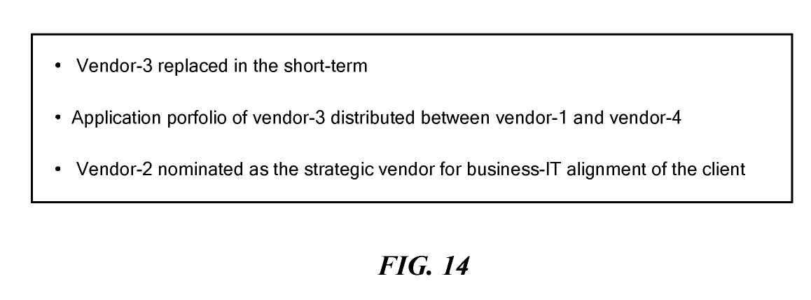

FIG. 13 also shows an exemplary performance-complexity matrix. In the example shown, the chosen strategy is business-process-wise consolidation. Complexity scores, performance scores, and maintenance costs have been calculated and given in a chart for each of four vendors with respect to the particular strategy component “Distribution and Logistics.” The complexity scores, performance scores, and maintenance costs also have been graphed on the performance-complexity matrix. As shown in FIG. 14, Vendor III is slated to be replaced in the short-term, because Vendor III has both a low performance score and a low complexity score. Vendors I and IV, having a high performance score and a low complexity score, are slated to take over the application portfolio currently handled by Vendor III. Vendor II, having both a high performance score and a high complexity score, is nominated as the strategic vendor for business-IT alignment.

The embodiments of the invention described above are intended to be merely exemplary; numerous variations and modifications will be apparent to those skilled in the art. All such variations and modifications are intended to be within the scope of the present invention as defined in the appended claims. For example, exemplary embodiments shown develop a roadmap for IT vendor consolidation, but the invention is not limited to this particular embodiment.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

A computer program that embodies the invention may be fixed in any form (e.g., source code form, computer executable form, or an intermediate form). The computer program, and any programmable logic that embodies the invention, may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program and programmable logic may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web). Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

What is claimed is:

1. A method of evaluating vendor capability, the method comprising:
selecting a set of grouping strategies, each grouping strategy including one or more software application groups;
in a first computer process, calculating a component consolidation potential (CP) score for each software application group in each grouping strategy;
determining an importance value for each software application group in each grouping strategy;
in a second computer process, calculating a net CP score for each grouping strategy using the importance values and the component CP scores;
selecting a grouping strategy from the set of grouping strategies based on the net CP scores; and
evaluating vendor capability according to the selected grouping strategy.

2. A method according to claim 1, further comprising:
determining a set of parameters and parameter weights;
wherein calculating a component CP score includes calculating based on values of the parameters and the parameter weights.

3. A method according to claim 2, wherein the parameter weights are normalized.

4. A method according to claim 1, wherein evaluating vendor capability includes evaluating complexity and performance of work performed by each vendor.

5. A method according to claim 4, wherein evaluating vendor capability further comprises:
calculating a performance score based on the performance evaluation for each of the set of vendors associated with an application group in the selected grouping strategy; and
calculating a complexity score based on the complexity evaluation for each of the set of vendors associated with an application group in the selected grouping strategy.

6. A method according to claim 5, wherein calculating a performance score includes:
determining a set of performance parameters and performance parameter weights; and
calculating the performance score based on values of the performance parameters and the performance parameter weights.

7. A method according to claim 5, wherein calculating a complexity score includes:
determining a set of complexity parameters and complexity parameter weights; and
calculating the complexity score based on values of the complexity parameters and the complexity parameter weights.

8. A method according to claim 1, wherein evaluating vendor capability further comprises evaluating vendor capability based on a maintenance cost.
